(19) United States
(12) Patent Application Publication
(10) Pub. No.: US 2023/0140790 A1
(43) Pub. Date: May 4, 2023

(54) Malware Victim Identification

(71) Applicant: Recorded Future, Inc., Somerville, MA (US)

(72) Inventors: Bill Ladd, Watertown, MA (US); Levi Gundert, El Cajon, CA (US); Chas Tomlin, Southampton (GB); Sanil Chohan, Stivichall (GB)

(21) Appl. No.: 17/516,175

(22) Filed: Nov. 1, 2021

(51) Int. Cl. H04L 9/40; H04L 43/026

(52) U.S. Cl. CPC H04L 63/1416; H04L 43/026; H04L 63/308

(57) ABSTRACT

Disclosed, in one general aspect, is a network security system that includes a network traffic analysis tool operative to extract information about traffic with suspected attack support infrastructure addresses. An automated traffic pattern recognition tool is responsive to information extracted by the network traffic analysis tool and to enrichment data, and is operative to detect patterns in the extracted traffic information. An identification tool is responsive to the pattern recognition tool to identify victims associated with the suspected attack support infrastructure addresses based on patterns detected in the extracted traffic information. And the system includes storage that is responsive to the identification tool for storing the recorded suspected attack support infrastructure addresses and identified victims on an ongoing basis.

### FIELD OF THE INVENTION

This invention relates to methods and apparatus for evaluating security and/or protecting systems on large computer networks, such as the Internet.

### BACKGROUND OF THE INVENTION

Administrators of large private networks, such as corporate or governmental networks, need to take steps to secure them from various types of attacks. Command-and-Control (C2) servers on the internet are important to identify because, if an organization has infected computers, they may try to communicate to external command and control machines operated by threat actors. If organizations can identity Internet Protocol (IP) addresses and domains associated with C2 servers, they can block that traffic at their firewall and mitigate the risk of infection.

### SUMMARY OF THE INVENTION

In one general aspect, the invention features a network security system that includes a network traffic analysis tool operative to extract information about traffic with suspected attack support infrastructure addresses. An automated traffic pattern recognition tool is responsive to information extracted by the network traffic analysis tool and to enrichment data, and is operative to detect patterns in the extracted traffic information. An identification tool is responsive to the pattern recognition tool to identify victims associated with the suspected attack support infrastructure addresses based on patterns detected in the extracted traffic information. And the system includes storage that is responsive to the identification tool for storing the recorded suspected attack support infrastructure addresses and identified victims on an ongoing basis.

In preferred embodiments, the traffic analysis tool can include a flow information extraction tool. The automated pattern recognition tool can be responsive to a plurality of third-party enrichment data sources. The system can further include an enrichment tool to enrich the stored addresses and victim identifications. The storage can be part of a larger database of threat data. The network security system can be operative to automatically identify at least hundreds of malware victims per day. The attack support infrastructure addresses can include malware controller addresses.

In another general aspect, the invention features a network security method that includes extracting information about traffic with suspected attack support infrastructure addresses, detecting patterns in the extracted traffic information, identifying victims associated with the suspected attack support infrastructure addresses based on patterns detected in the extracted traffic information, and storing the recorded suspected attack support infrastructure addresses and identified victims on an ongoing basis.

In a further general aspect, the invention features a network security system that includes means for extracting information about traffic with suspected attack support infrastructure addresses, means for detecting patterns in the extracted traffic information, means for identifying victims associated with the suspected attack support infrastructure addresses based on patterns detected in the extracted traffic information, and means for storing the recorded suspected attack support infrastructure addresses and identified victims on an ongoing basis.

Systems according to the invention can help network administrators to detect, understand, and remedy risks posed by malware that communicates with command-and-control servers or other types of attack infrastructure.

### BRIEF DESCRIPTION OF THE DRAWING

FIG. 1 is a block diagram of an illustrative network security system according to the invention deployed on a network to identify and catalog malware victims;

FIG. 2 is a more detailed block diagram of the network security system of FIG. 1; and

FIG. 3 is a flowchart illustrating the operation of the system of FIGS. 1-2.

### DETAILED DESCRIPTION OF AN ILLUSTRATIVE EMBODIMENT

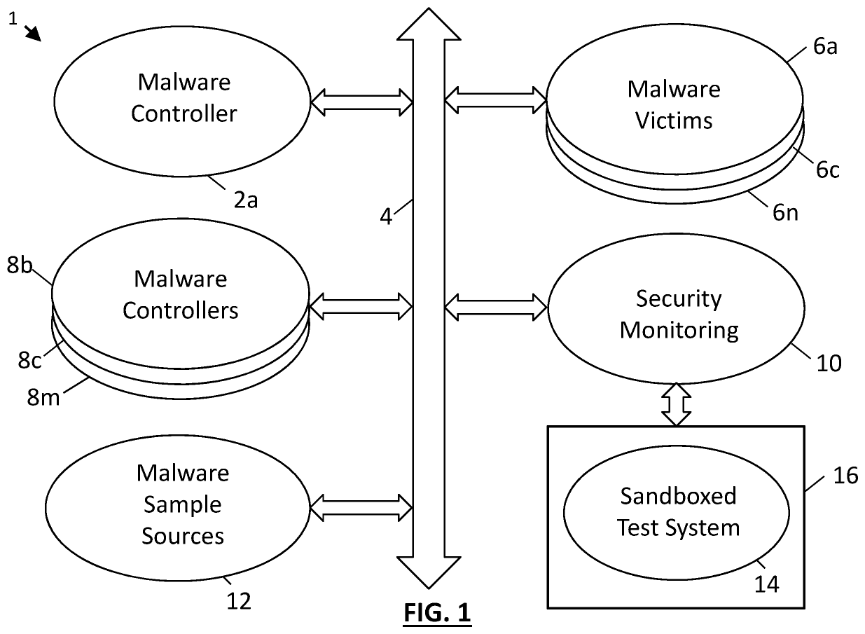

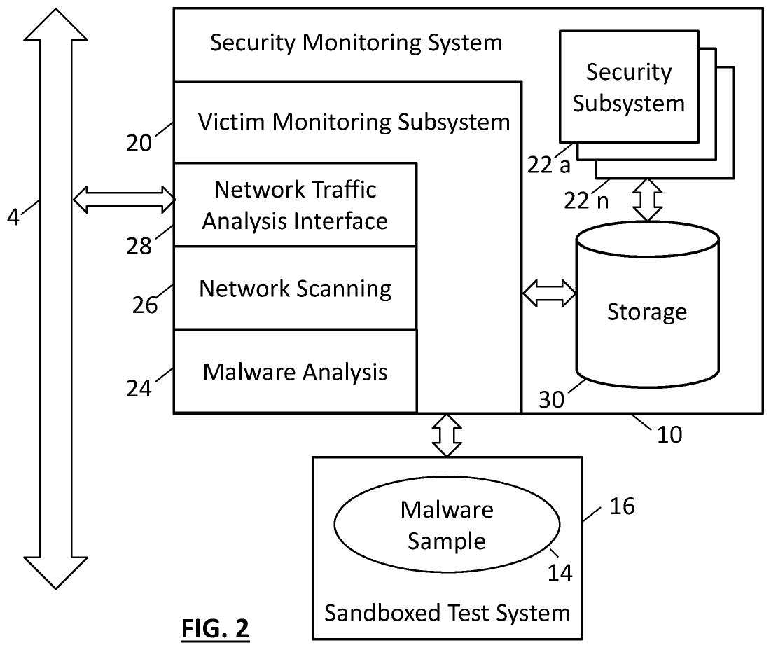

Referring to FIGS. 1 and 2, a network security monitoring system 10 is deployed to monitor activity on a wide area network 4, such as the Internet, for the purpose of monitoring, reporting and/or remediating network security threats. It includes a victim monitoring subsystem 20, which is preferably implemented as part of a larger monitoring system that also includes other security subsystems 22. These systems can share at least some common storage 30, such as a database, to store different types of threat data.

In one embodiment, the security monitoring system includes features of the Recorded Future Temporal Analytics Engine, which is described in more detail in U.S. Pat. No. 8,468,153 entitled INFORMATION SERVICE FOR FACTS EXTRACTED FROM DIFFERING SOURCES ON A WIDE AREA NETWORK and in U.S. Publication No. 20180063170 entitled NETWORK SECURITY SCORING. Related technology is also discussed in the paper entitled “Proactive Threat Identification Neutralizes Remote Access Trojan Efficiency,” by Levi Gundert (2016) and in the application entitled MALWARE ANALYSIS PIPELINE, docket number A0007-024001, filed on the same date as this application. The documents referenced in this paragraph are all herein incorporated by reference.

As shown in FIG. 2, the victim monitoring subsystem 20 interfaces with a sandboxed test system 16 that can run a malware sample 14 or attacker tool in a sandboxed environment. It additionally includes a malware analysis module 24, a network scanning interface 26, and a network traffic analysis interface 28.

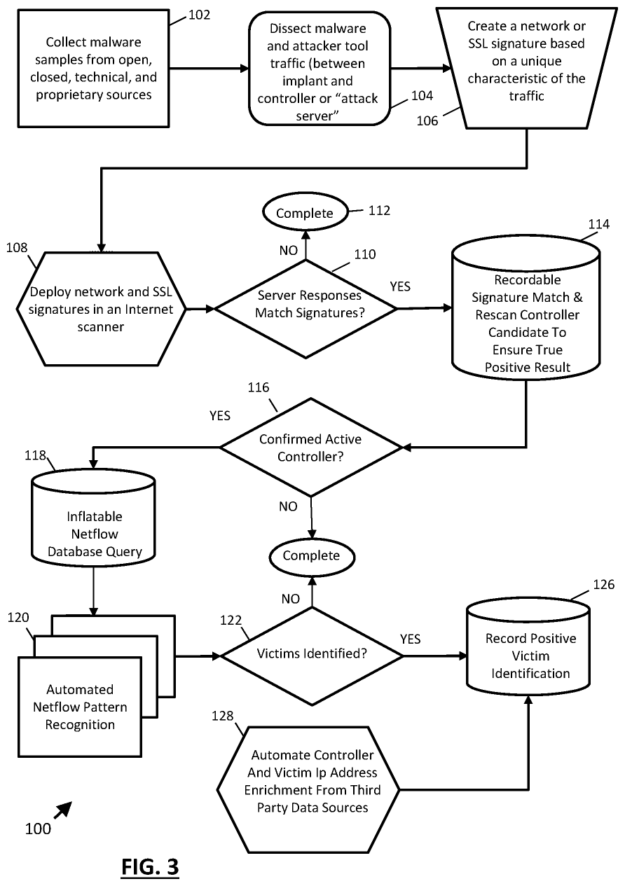

Referring also to FIG. 3, the victim monitoring subsystem 20 collects malware and/or attacker tool samples from malware sample sources 12, such as open, closed, technical, and proprietary sources (step 102). It runs these samples in the sandboxed environment and dissects the resulting malware and attacker tool traffic between the sandboxed malware or attacker tool 14 and its command-and-control server or attack server 2a. It can then create a network or SSL signature based on a unique characteristic of the traffic (step 106). This step can be repeated for a number of samples to obtain a number of signatures. Signatures can also be obtained in other ways, such as by purchasing them from third-party sources, or by manually running malware samples in a sandboxed environment.

The victim monitoring subsystem 20 can then use its network scanning interface to scan some or all of the network 4 to identify one or more new malware controllers and/or attack servers 8b . . . 8m and store their addresses, based on the signatures (steps 108, 110, 112). The scanning interface preferably uses one or more third-party, large-scale scanning tools, such as Unicorn Scan, Zmap, or MASSCAN. These tools can be configured to scan large parts of a network, such as all of the IP addresses in a defined address range, all of the IP addresses in a geographical area, or all of the IP addresses in the IPv4 and/or IPv6 address spaces, while excluding government and military IP addresses as appropriate. The victim monitoring subsystem 20 can then perform a second, more detailed scan directed at the candidate controllers or attack servers that yielded positive scan results, to confirm their status as controllers or attack servers (steps 114, 116).

The victim monitoring subsystem 20 then uses its network traffic analysis interface 28 to find the confirmed IP addresses in network traffic. This can be performed, for example, by using the confirmed IP addresses as input to a flow information extraction tool, such as NetFlow. This process can involve searching for the confirmed IP addresses in a database of Internet traffic received from distributed monitoring locations on the network, such as routers, to automatically find traffic patterns that identify victims of the malware or attack tools corresponding to the confirmed IP addresses (steps 118, 120, 122). Enrichment data from third parties or other security subsystems 22a . . . 22b can be used to enhance this process.

Records for victims identified by the network traffic analysis interface 28 can then be stored in the storage 30 (step 126). These stored records can be associated with enrichment data upon storage and/or over time thereafter. Enrichment data can include information a wide variety of sources, such as from third-party organizations, who is data, telemetry data, data obtained from honeypots or forensics, and third party geolocation data. Data about organizational relationships between entities can also be used, as provided for in US Patent Publication No. 2021-0042409 entitled AUTOMATED ORGANIZATIONAL SECURITY SCORING SYSTEM, published Dec. 24, 2020.

The resulting enhanced data set can be used in a variety of ways to manage risk. The system described above has been implemented in connection with digital logic, storage, and other elements embodied in special-purpose software running on a general-purpose computer platform, but it could also be implemented in whole or in part using virtualized platforms and/or special-purpose hardware. And while the system can be broken into the series of modules and steps shown in the various figures for illustration purposes, one of ordinary skill in the art would recognize that it is also possible to combine them and/or split them differently to achieve a different breakdown.

The embodiments presented above can benefit from temporal and linguistic processing and risk scoring approaches outlined in US Patent Publication No. 2020-0401961 entitled CROSS-NETWORK SECURITY EVALUATION, published Feb. 11, 2021 and US Patent Publication No. 2021-0042409 entitled AUTOMATED ORGANIZATIONAL SECURITY SCORING SYSTEM, published Dec. 24, 2020 and the documents they refer to. The documents referenced directly and indirectly in this paragraph are all herein incorporated by reference. Also herein Incorporated by reference is version 5 of the NetFlow standard.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A network security system, comprising:
a network traffic analysis tool operative to extract information about traffic with suspected attack support infrastructure addresses,
an automated traffic pattern recognition tool that is responsive to information extracted by the network traffic analysis tool and to enrichment data, and is operative to detect patterns in the extracted traffic information,
an identification tool responsive to the pattern recognition tool to identify victims associated with the suspected attack support infrastructure addresses based on patterns detected in the extracted traffic information, and
storage responsive to the identification tool for storing the recorded suspected attack support infrastructure addresses and identified victims on an ongoing basis.

2. The system of claim 1 wherein the traffic analysis tool includes a flow information extraction tool.

3. The system of claim 1 wherein the automated pattern recognition tool is responsive to a plurality of third-party enrichment data sources.

4. The system of claim 1 further including an enrichment tool to enrich the stored addresses and victim identifications.

5. The system of claim 1 wherein the storage is part of a larger database of threat data.

6. The system of claim 1 wherein the network security system is operative to automatically identify at least hundreds of malware victims per day.

7. The system of claim 1 wherein the attack support infrastructure addresses include malware controller addresses.

8. A network security method, comprising:
extracting information about traffic with suspected attack support infrastructure addresses,
detecting patterns in the extracted traffic information,
identifying victims associated with the suspected attack support infrastructure addresses based on patterns detected in the extracted traffic information, and
storing the recorded suspected attack support infrastructure addresses and identified victims on an ongoing basis.

9. A network security system, comprising:
means for extracting information about traffic with suspected attack support infrastructure addresses,
means for detecting patterns in the extracted traffic information,
means for identifying victims associated with the suspected attack support infrastructure addresses based on patterns detected in the extracted traffic information, and
means for storing the recorded suspected attack support infrastructure addresses and identified victims on an ongoing basis.
